(19) United States
(12) Patent Application Publication
(10) Pub. No.: US 2006/0203014 A1
(43) Pub. Date: Sep. 14, 2006

(54) Convertible computer system

(76) Inventors: Jeffrey A. Lev, Cypress, TX (US); Pablo J. Salazar, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/076,085

(22) Filed: Mar. 9, 2005

(51) Int. Cl. G09G 5/00

(52) U.S. Cl. 345/659

(57) ABSTRACT

A convertible computer system comprises a display member coupled to a base member to enable positioning of the display member relative to the base member in either a laptop mode or tablet mode. The system also comprises a non-contact sensor system adapted to automatically change an orientation of an image displayed by a display element of the display member in response to the display element being re-positioned relative to the base member.

### BACKGROUND OF THE INVENTION

Convertible portable computers can generally be transformed from a notebook or clamshell mode to a tablet mode by rotating or otherwise manipulating the orientation of a display member of the portable computer relative to a base member of the portable computer. However, after changing the portable computer from notebook mode to tablet mode, or vice versa, a change in the viewing orientation of images displayed on a display member may be desired, thereby requiring further manipulation of the portable computer (e.g., rotation of the portable computer) or other action by the user to cause a change in the orientation of the images displayed by the portable computer (e.g., selection of an icon or other software-based mechanism). One type of portable computer utilizes a mechanical switch mechanism to change the orientation of the displayed image in response to physical contact and/or actuation of the switch (e.g., contact of an arm or other type of structure extending from the display member with a switch mounted in the base member when the display member is positioned in a tablet mode). However, such types of mechanisms are subject to damage and/or contamination (e.g., from dust, dirt or other types of debris).

### BRIEF DESCRIPTION OF THE DRAWINGS

For a more complete understanding of the present invention and the advantages thereof, reference is now made to the following descriptions taken in connection with the accompanying drawings in which:

FIGS. 1A-1C are diagrams illustrating an embodiment of a computer system in accordance with the present invention depicted in various modes of use; and

FIGS. 2A and 2B are diagrams illustrating an embodiment of the computer system illustrated in FIGS. 1A-1C with portions broken away

### DETAILED DESCRIPTION OF THE DRAWINGS

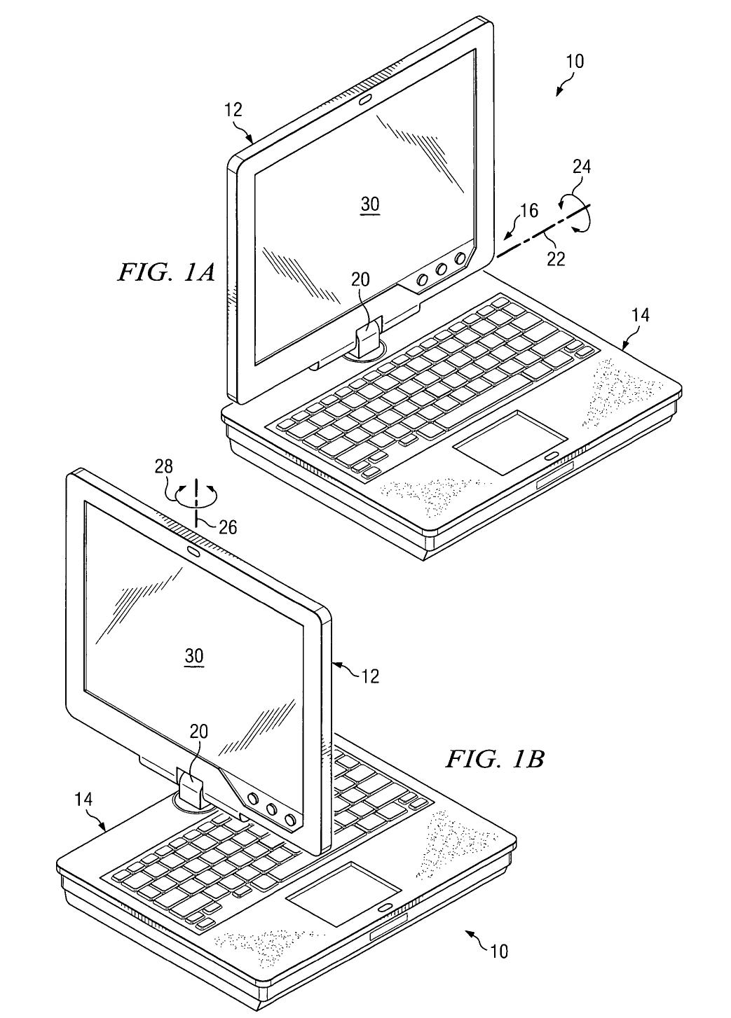

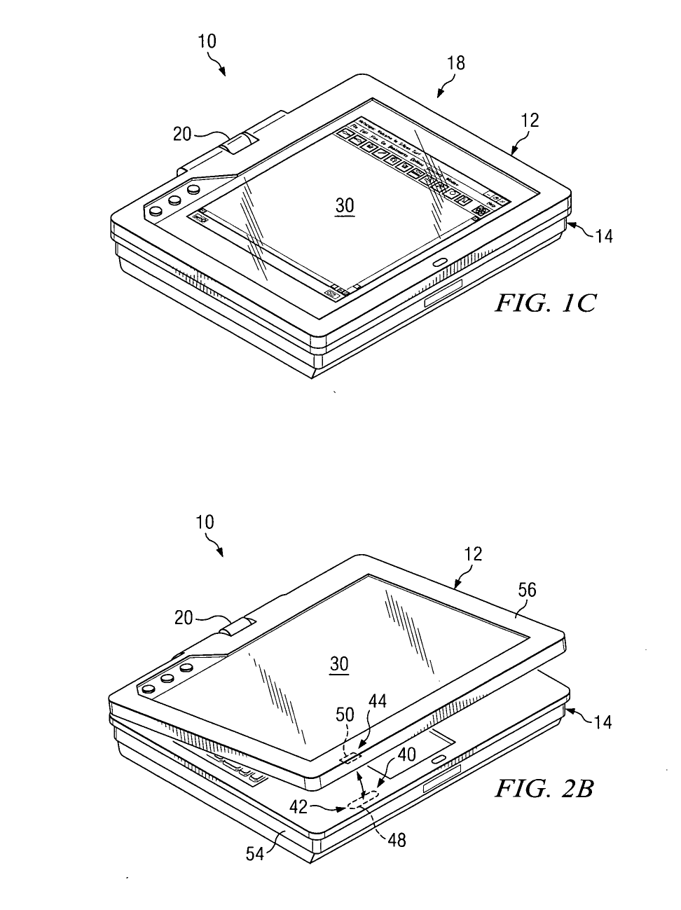

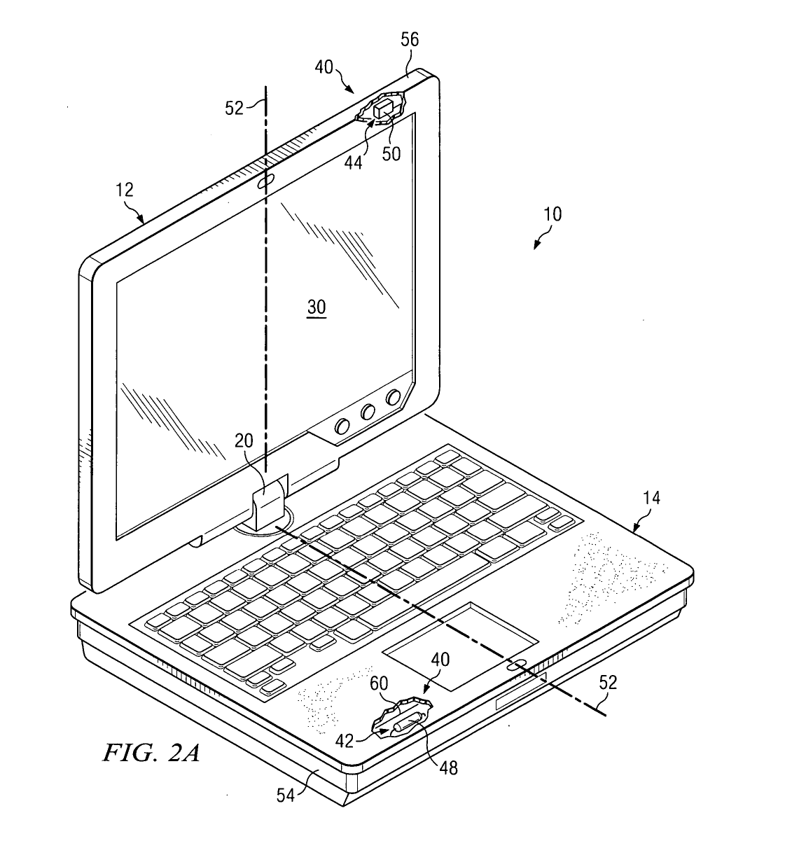

The preferred embodiments of the present invention and the advantages thereof are best understood by referring to FIGS. 1A-2B of the drawings, like numerals being used for like and corresponding parts of the various drawings.

FIGS. 1A-1C are diagrams illustrating an embodiment of a convertible computer system 10 in accordance with the present invention. In the embodiment illustrated in FIGS. 1A-1C, system 10 comprises a display member 12 coupled to a base member 14 to enable positioning of display member 12 relative to base member 14 in either a notebook or laptop mode, indicated generally by 16 in FIG. 1A, or a tablet mode, indicated generally by 18 in FIG. 1C. For example, in the embodiment illustrated in FIGS. 1A-1C, display member 12 is coupled to base member 14 via a hinge assembly 20 to enable rotation of display member 12 about an axis 22 in the direction indicated generally by 24 in FIG. 1A relative to base member 14, and rotation of display member 12 about an axis 26 in the direction indicated generally by 28 in FIG. 1B relative to base member 14.

Thus, in operation, system 10 is convertible and/or otherwise transformable from laptop mode 16 to tablet mode 18, or vice versa, by rotating display member 12 about axis 26 in the direction indicated generally by 28 and rotating display member 12 about axis 22 in the direction indicated generally by 24 to position a display element 30 of display member 12 in a desired position corresponding to either laptop mode 16 or tablet mode 18. FIGS. 1A-1C progressively illustrate system 10 being converted and/or otherwise transformed from laptop mode 16 to tablet mode 18 such that, in tablet mode 18, display member 12 is positioned against and/or otherwise in close proximity to base member 14 to enable use of display element 30 in tablet mode 18. It should be understood that system 10 is convertible and/or otherwise transformable from tablet mode 18 to laptop mode 16 by reversing the operations depicted in FIGS. 1A-1C.

FIGS. 2A-2B are diagrams illustrating an embodiment of computer system 10 of FIGS. 1A-1C with portions broken away. In the embodiment illustrated in FIGS. 2A-2B, system 10 comprises a non-contact sensor system 40 for automatically changing and/or modifying an orientation of an image displayed by display element 30 of display member 12 in response to display element 30 being converted to or from tablet mode 18 and/or otherwise re-positioned relative to base member 14 (e.g., re-positioning display element 30 to a position facing away from base member 14 as in tablet mode 18 or to a position facing toward base member 14 as in laptop mode 16). For example, in the embodiment illustrated in FIGS. 2A-2B, sensor system 40 comprises a sensor element 42 disposed in base member 14 and a sensor element 44 disposed in display member 12 for automatically changing the orientation of an image displayed by display element 30 in response to sensor elements 42 and 44 being positioned within a predetermined distance and/or in close proximity to each other and, therefore, alleviating any need for contact between base member 12 and display member 12 and/or any switch, latch or other type of structure extending therebetween for automatically changing the orientation of an image displayed by display element 30. In the embodiment illustrated in FIGS. 2A-2B, sensor element 42 comprises a reed switch 48 and sensor element 44 comprises a magnet 50 such that reed switch 48 is responsive to a magnetic field generated by magnet 50. However, it should be understood that other types of non-contact sensor elements may be used in sensor system 40 for detecting the positioning of display member 12 relative to base member 14 in tablet mode 18. Additionally, it should be understood that the location and/or position of reed switch 48 and magnet 50 may be otherwise reversed (e.g., reed switch 48 located in display member 12 and magnet 50 located in base member 14).

In the embodiment illustrated in FIGS. 2A-2B, sensor elements 42 and 44 are each asymmetrically located on base member 14 and display member 12, respectively, relative to a medial plane of system 10, indicated generally by 52 in FIG. 2A, and opposite each other relative to medial plane 52, when display member 12 is positioned in laptop mode 16. Further, sensor elements 42 and 44 are located on base member 14 and display member 12, respectively, such that sensor elements 42 and 44 are generally aligned with each other when display member 12 is located in tablet mode 18 as illustrated in FIG. 1C. Further, sensor elements 42 and 44 are distally located on respective base member 14 and display member 12 relative to hinge assembly 20. However, it should be understood that sensor elements 42 and 44 may be otherwise located on base member 14 and display member 12, respectively (e.g., near hinge assembly 20, medially located between hinge assembly 20 and a distal location on base member 14 and display member 12, respectively, or elsewhere). Correspondingly, sensor elements 42 and 44 being asymmetrically disposed relative to medial plane 52 of system 10 and opposite each other relative to medial plane 52 of system 10 in laptop mode 16 results in non-interaction of sensor elements 42 and 44 upon closure of display member 12 relative to base member 14 when display member 12 is in the laptop mode 16.

Thus, in operation, referring to FIG. 2B, when display member 12 is rotated about axis 26 and then correspondingly rotated about axis 22 (as illustrated in FIGS. 1A-1C) to position display member 12 in tablet mode 18, sensor element 44 becomes generally aligned with a location of sensor element 42. Further, as display member 12 is rotated about axis 22 into tablet mode 18, the magnetic field generated by magnet 50 nears reed switch 48 causing actuation of reed switch 48. Actuation of reed switch 48 causes an interrupt and/or other type of signal generated and/or otherwise processed via hardware, software, or a combination of hardware and software of system 10, to automatically change an orientation of an image displayed by display element 30. Accordingly, as sensor element 44 nears sensor element 42 (e.g., as sensor element 44 comes within a predetermined distance and/or otherwise comes within close proximity to sensor element 42) thereby indicating positioning of display member 12 in tablet mode 18, sensor system 40 automatically changes an orientation of an image displayed by display element 30 (e.g., from landscape mode to portrait mode). Correspondingly, in some embodiments of the present invention, converting and/or otherwise transforming system 10 from tablet mode 18 to laptop mode 16 causes a re-orientation of an image displayed by display element 30 to a previous orientation. For example, in operation, as display member 12 is moved away from base member 14 to convert system 10 from tablet mode 18 to laptop mode 16, magnet 50 is moved away from reed switch 48, thereby causing a reduction and/or eventual dissipation of the magnetic field of magnet 50 in an area proximate to reed switch 48 and causing reed switch 48 to de-actuate. Accordingly, upon de-actuation of reed switch 48, an image displayed by display element 30 is re-oriented to an original or previous orientation.

In the embodiment illustrated in FIGS. 2A-2B, sensor elements 42 and 44 are disposed within a base member housing 54 and a display member housing 56, respectively, thereby preventing and/or otherwise eliminating user interaction with sensor system 40 and preventing and/or otherwise eliminating the possibility of debris or other types of damage to sensor system 40. Additionally, as illustrated in FIGS. 2A-2B, practically any type of base member 14 and display member 12 are easily configurable and/or adaptable for use in a system enabling both laptop mode 16 and tablet mode 18 whether or not such base member 14 and display member 12 were originally configured for such use. For example, in the embodiment illustrated in FIGS. 2A-2B, sensor element 42 is disposed on a printed circuit board assembly 60 which may be inserted and/or otherwise disposed within base member 14 and communicatively coupled to a motherboard or other electronic assembly within system 10, thereby alleviating production of a base member 14 specially configured for such convertible use. Similarly, in the embodiment illustrated in FIGS. 2A-2B, magnet 50 is located within a generally unused or open area within display member housing 56, thereby alleviating any need for production of a display member 12 that is specially configured for such convertible use. Further, embodiments of the present invention provide an automatic re-orientation of an image displayed by display element 30 when display member 12 is converted from laptop mode 16 to tablet mode 18, and/or vice versa, without a user having to manually adjust or re-orient the image and/or requiring physical contact between display member 12 and base member 14 to trigger such re-orientation.

What is claimed is:

1. A convertible computer system, comprising:
a display member coupled to a base member to enable positioning of the display member relative to the base member in either a laptop mode or tablet mode; and
a non-contact sensor system adapted to automatically change an orientation of an image displayed by a display element of the display member in response to the display element being re-positioned relative to the base member.

2. The system of claim 1, wherein the non-contact sensor system comprises a switch actuatable in response to the display element being proximally positioned relative to the base member.

3. The system of claim 2, wherein the switch is actuatable in response to the display element being moved within a predetermined distance of the base member in the tablet mode.

4. The system of claim 2, wherein the switch is actuatable in response to the display element being moved a predetermined distance relative to the base member to the laptop mode.

5. The system of claim 1, wherein the non-contact sensor system comprises:
a magnet; and
a reed switch responsive to the magnet.

6. The system of claim 1, wherein the non-contact sensor system comprises a sensor element disposed in the display member in alignment with a sensor element in the base member when the display member is positioned in the tablet mode.

7. The system of claim 1, wherein the non-contact sensor system is adapted to automatically change the orientation of the image from a landscape mode to a portrait mode when the display element is positioned in the tablet mode.

8. The system of claim 1, wherein the non-contact sensor system is adapted to automatically change the orientation of the image from a portrait mode to a landscape mode when the display element is positioned in the laptop mode.

9. The system of claim 1, wherein the non-contact sensor system comprises a sensor element disposed at a distal location of the display member relative to a hinge assembly of the computer system.

10. The system of claim 1, wherein the non-contact sensor system is adapted to automatically change the orientation of the image in response to the display element being re-positioned relative to the base member.

11. A convertible computer system, comprising:
non-contact means for automatically changing an orientation of an image displayed by a display element of a display member of the computer system in response to the display element being re-positioned relative to a base member of the computer system.

12. The system of claim 11, wherein the non-contact means comprises means for detecting the display element being positioned to be within a predetermined distance of the base member.

13. The system of claim 11, wherein the non-contact means comprises a switch means responsive to a magnetic field.

14. The system of claim 11, wherein the non-contact means comprises a sensor means located on the base member adapted to detect proximity of the display element relative to the base member.

15. The system of claim 11, wherein the non-contact means comprises a sensor means located in the base member responsive to a presence of a sensor means disposed in the display member.

16. A method for manufacturing a computer system, comprising:
providing a non-contact sensor system for automatically changing an orientation of an image displayed by a display element of a display member of the computer system in response to the display element being re-positioned relative to a base member of the computer system.

17. The method of claim 16, wherein providing the non-contact sensor system comprises providing a sensor element adapted to detect proximity of the display element relative to the base member.

18. The method of claim 16, wherein providing the non-contact sensor system comprises providing a sensor element disposed in the base member responsive to a presence of a sensor element disposed in the display member.

19. The method of claim 16, wherein providing the non-contact sensor system comprises providing a switch disposed in at least one of the display member and the base member responsive to a magnetic field.

20. The method of claim 16, wherein providing the non-contact sensor system comprises providing a sensor element adapted to detect re-positioning of the display member into or from a tablet mode.
